(19) United States
(12) Patent Application Publication
(10) Pub. No.: US 2007/0005837 A1
(43) Pub. Date: Jan. 4, 2007

(54) Personal portable storage device

(76) Inventors: Martin Yu-Wen Chen, San Jose, CA (US); Fu-Ying Huang, San Jose, CA (US)

Correspondence Address: WAGNER, MURABITO & HAO LLP;Third Floor, Two North Market Street, San Jose, CA, 95113, US

(21) Appl. No.: 11/170,655

(22) Filed: Jun. 29, 2005

(51) Int. Cl. G06F 13/38

(52) U.S. Cl. 710/62

(57) ABSTRACT

A personal portable storage device (PPSD). The PPSD has a storage medium. The PPSD also includes a wireless component, coupled to the storage medium. Additionally, the PPSD includes transfer management electronics, coupled to the storage medium, which allow a host device to access the PPSD through the wireless component without requiring physical connections between the PPSD and the host device. The PPSD includes a self-contained energy source, coupled to the transfer management electronics. The PPSD also has a housing, which at least partially encloses the storage medium, the wireless component, the energy source, and the transfer management electronics, and is of a size and shape well-suited to being carried on a person, so that the PPSD is easy to transport.

### BACKGROUND

1. Field of the Invention

The present invention relates to the field of personal electronic devices. Specifically, embodiments relate to a portable device which may wirelessly interface with other personal electronic devices in order to provide increased data storage capacity.

2. Related Art

Hard disk drives are used in almost all computer system operations. In fact, most computing systems are not operational without some type of hard disk drive to store the most basic computing information such as the boot operation, the operating system, the applications, and the like. In general, the hard disk drive is a device which may or may not be removable, but without which the computing system will generally not operate.

The basic hard disk drive model includes a storage disk or hard disk that spins at a designed rotational speed. An actuator arm with a suspended slider is utilized to reach out over the disk. The arm carries a head assembly that has a magnetic read/write transducer or head for reading/writing information to or from a location on the disk. The complete head assembly, e.g., the suspension and head, is called a head gimbal assembly (HGA).

In operation, the hard disk is rotated at a set speed via a spindle motor assembly having a central drive hub. Additionally, there are tracks evenly spaced at known intervals across the disk. When a request for a read of a specific portion or track is received, the hard disk aligns the head, via the arm, over the specific track location and the head reads the information from the disk. In the same manner, when a request for a write of a specific portion or track is received, the hard disk aligns the head, via the arm, over the specific track location and the head writes the information to the disk.

Over the years, the disk and the head have undergone great reductions in their size. Much of the refinement has been driven by consumer demand for smaller and more portable hard drives such as those used in personal digital assistants (PDAs), MP3 players, and the like. For example, the original hard disk drive had a disk diameter of 24 inches. Modern hard disk drives are much smaller and include disk diameters of less than 2.5 inches (micro drives are significantly smaller than that). Advances in magnetic recording are also primary reasons for the reduction in size.

Most portable electronics devices have very limited storage capacity. Electronics like mobile phones, personal digital assistants, digital cameras and camcorders, and mp3 players, which may be referred to as host devices, would all benefit from having larger storage space. Manufacturers of such products face very real limitations to increasing storage capacity, however. Hard disk drives (HDDs) are expensive in terms of volume and power consumption, while other storage devices like Compact Flash cards have, again, very limited capacity.

One imperfect solution for portable storage capacity is the various devices designed to use the Universal Serial Bus (USB) interface. Such devices may include Compact Flash cards or similar solid-state storage formats, while others use small HDDs. These USB storages devices have several constraints on them, however. First, they require a physical connection, and so the host device must include a USB port to make use of them, and then the USB device and host device must remain physically connected for the duration of the use. Additionally, power for these USB storage devices must come from the host device. Finally, only one host device may make use of a single USB storage device at a time.

### SUMMARY

A personal portable storage device (PPSD). The PPSD has a storage medium. The PPSD also includes a wireless component, coupled to the storage medium. Additionally, the PPSD includes transfer management electronics, coupled to the storage medium, which allow a host device to access the PPSD through the wireless component without requiring physical connections between the PPSD and the host device. The PPSD includes a self-contained energy source, coupled to the transfer management electronics. The PPSD also has a housing, which at least partially encloses the storage medium, the wireless component, the energy source, and the transfer management electronics, and is of a size and shape well-suited to being carried on a person, so that the PPSD is easy to transport.

### BRIEF DESCRIPTION OF THE DRAWINGS

FIG. 1 is a schematic top plan view of a hard disk drive, in accordance with one embodiment of the present invention.

FIG. 2 is a representation of one potential use in accordance with one embodiment of the present invention.

FIG. 3 is a diagram of the elements of a personal portable storage device, in accordance with one embodiment of the present invention.

FIG. 4 is a flowchart of data transfer between a personal portable storage device and a host device, in accordance with one embodiment of the present invention.

FIG. 5 is a flowchart of data transfer between a personal portable storage device and a plurality of host devices, in accordance with one embodiment of the present invention.

FIG. 6 is a depiction of an example of a personal portable storage device that would fit in a shirt pocket, in accordance with one embodiment of the present invention.

### DETAILED DESCRIPTION

A personal portable storage device and a hard disk apparatus configured for use as a personal portable storage device are disclosed. Reference will now be made in detail to several embodiments of the invention. While the invention will be described in conjunction with the alternative embodiment(s), it will be understood that they are not intended to limit the invention to these embodiments. On the contrary, the invention is intended to cover alternative, modifications, and equivalents, which may be included within the spirit and scope of the invention as defined by the appended claims.

Furthermore, in the following detailed description of the present invention, numerous specific details are set forth in order to provide a through understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

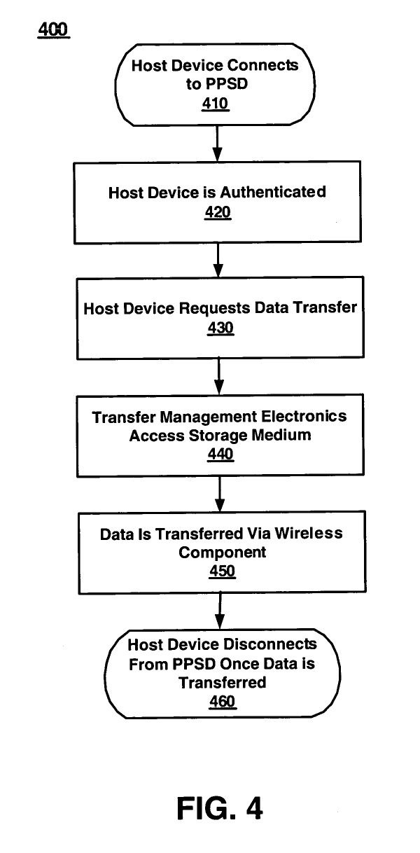

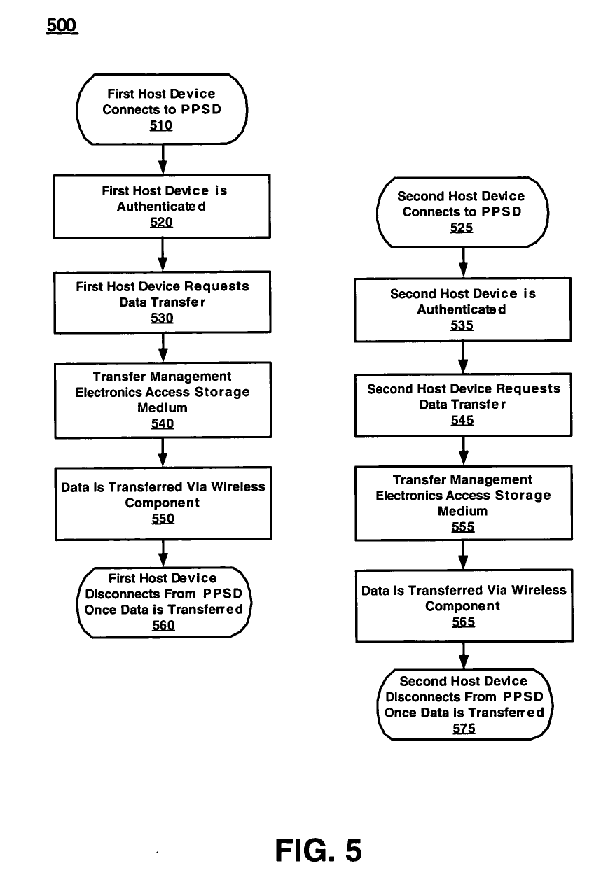

Portions of the detailed description that follows are presented and discussed in terms of a process. Although steps and sequencing thereof are disclosed in figures herein (FIG. 4 and FIG. 5) describing the operations of one embodiment of the present invention, such steps and sequencing are exemplary. Embodiments of the present invention are well-suited to performing various other steps or variations of the steps recited in the flowchart of the figure herein, and in a sequence other than that depicted and described herein.

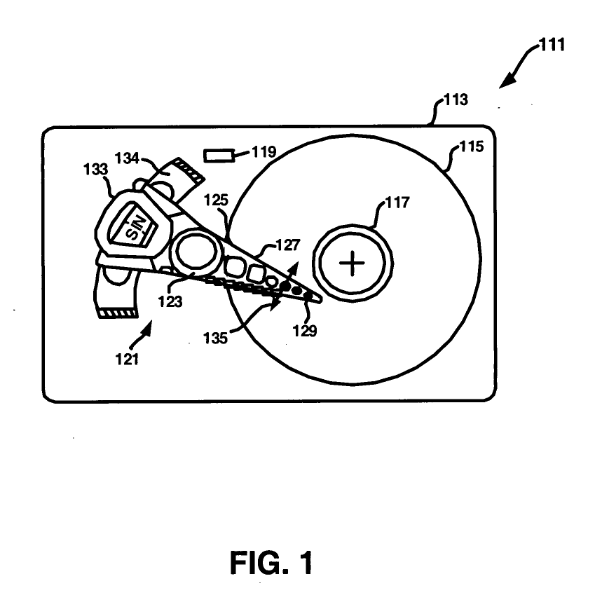

With reference now to FIG. 1, a schematic drawing of one embodiment of an information storage system comprising a magnetic hard disk file or drive 111 for a computer system is shown. Drive 111 has an outer housing or base 113 containing a disk pack having at least one media or magnetic disk 115. A spindle motor assembly having a central drive hub 117 rotates the disk or disks 115. An actuator 121 comprises a plurality of parallel actuator arms 125 (one shown) in the form of a comb that is movably or pivotally mounted to base 113 about a pivot assembly 123. A controller 119 is also mounted to base 113 for selectively moving the comb of arms 125 relative to disk 115.

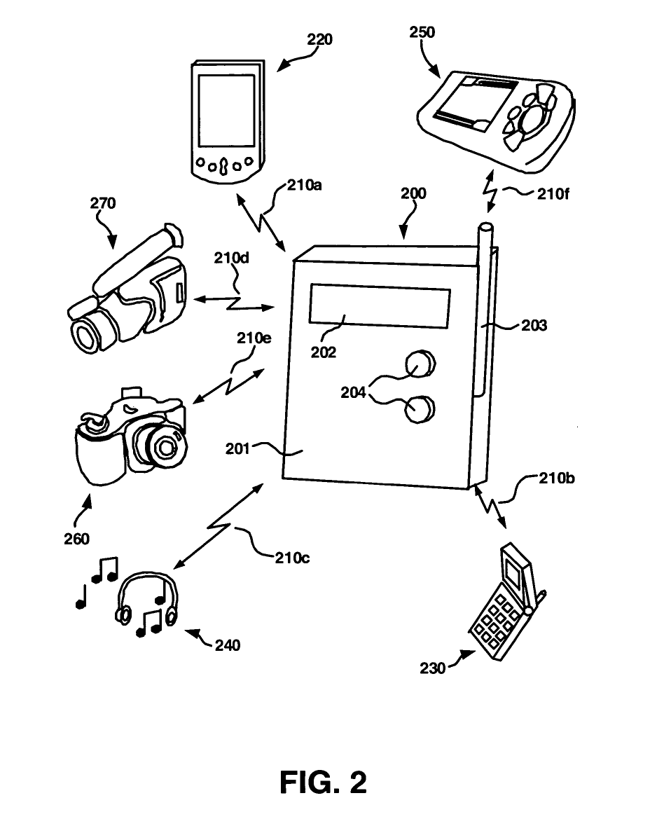

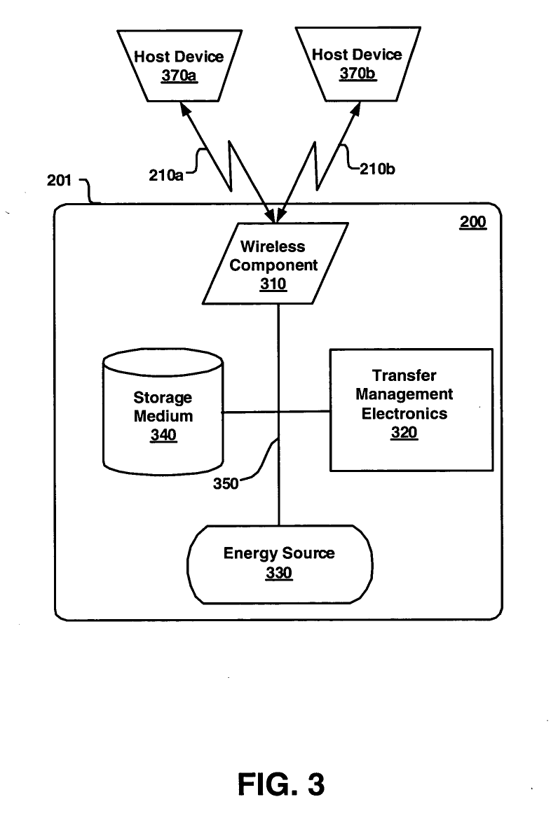

With reference now to FIG. 2, a representation of one potential use of one embodiment of a personal portable storage device (PPSD) is shown. PPSD 200 has a housing 201. PPSD 200 also includes an LCD display 202, an external antenna 203, and several external buttons 204. It should be understood that PPSD 200 is representative of one embodiment of the present invention only. In an alternative embodiment, housing 201 has another form factor and does not fully enclose the elements discussed in relation to FIG. 3. In another embodiment, PPSD 200 includes several LEDs in place of display 202. In another embodiment, PPSD 200 does not include any visual display. In another embodiment, external antenna 203 has a different form factor and is located elsewhere on PPSD 200. In another embodiment, PPSD 200 does not include an external antenna. In yet another embodiment, external buttons 204 are replaced with a control knob. In another embodiment, external buttons 204 are replaced with a touch-sensitive input device. In yet another embodiment, PPSD 200 does not include external input devices.

PPSD 200 is shown communicating wirelessly, as depicted by arrows 210, with a number of electronic devices capable of wireless communication, hereafter called host devices. Host device 220, a personal digital assistant (PDA), host device 230, a cellular telephone, host device 240, a portable music-playing device, host device 250, a global positioning system (GPS) device, host device 260, a digital camera, and host device 270, a digital camcorder, are intended to be exemplary only. In one embodiment, PPSD 200 communicates wirelessly with any electronic device capable of wireless communication, including but not limited to devices such as: PDAs; mobile telephones; portable music-playing devices; laptop, desktop, and hand-held computers; watches; automobiles; “smart” appliances; and medical monitoring equipment. In one embodiment, wireless communications happen sequentially, with only one host device communicating with PPSD 200 at a time. In another embodiment, wireless communication happens simultaneously, with multiple host devices communicating with PPSD 200 during the same or overlapping time intervals. This embodiment offers a substantial advantage over traditional portable storage devices, which only allow one host device to access the storage device at a time.

With reference now to FIG. 3, a diagram of the internal elements of one embodiment of the present invention is shown. PPSD 200 still has a housing 201, and that housing encloses a wireless component 310, transfer management electronics 320, an energy source 330, and a storage medium 340, all coupled to an internal bus 350. Alternative embodiments of the present invention have housing 201 only partially enclosing some or all of these elements. Another embodiment of the present invention includes shock-mounting as part of housing 201. Including shock-mounting helps protect the components of PPSD 200, particularly storage medium 240, from damage caused by a sudden physical shock, such as that caused by dropping PPSD 200 off a table or out of a pocket. Another embodiment constructs housing 201 in such as way as to render housing 201 waterproof. Waterproofing housing 201 protects PPSD 200 from a number of water-related dangers, including inclement weather, spilled beverages, and high humidity.

Wireless component 310 is a transmitter and receiver for communicating wirelessly with a host device 370. One embodiment uses wireless component 310 to communicate wirelessly with a plurality of host devices 370a and 370b, as depicted by arrows 210a and 210b. One embodiment uses a transmitter and receiver that is compliant with the Ultra WideBand standard. An alternative embodiment uses a transmitter and receiver that is compliant with the Bluetooth standard, or with the 802.11a, 802.11b, or 802.11g standard. Allowing for communication with a host device via a wireless component offers a substantial advantage over traditional portable storage devices, which require an awkward physical connection between the storage device and the host device. One consideration for selecting wireless component 310, according to one embodiment, is that it have a high bandwidth and use little power, with range the least important consideration. A high bandwidth allows PPSD 200 to transmit and receive data from host device 370 quickly, while low power consumption means that energy source 230 will not need to be replaced or recharged as often as would otherwise be the case. A short range for wireless component 310 allows for this reduced power consumption, and also prevents PPSD 200 from accidentally communicating or interfering with other wireless communications devices. According to one embodiment, the range for wireless component 310 should be sufficient to allow PPSD 200 to be carried in a pocket and allow access to a host device 370 being held in the hands or worn on the body. According to another embodiment, the range for wireless component 310 should be sufficient to allow PPSD 200 to access a host device 370 located in the same room.

The transfer management electronics 320, according to one embodiment, allow a host device 370 to access the storage medium 340. According to one embodiment, the transfer management electronics 320 may provide error correction. The inclusion of error correction helps to ensure data integrity, preventing incorrect data from being stored on PPSD 200 or being transmitted to a host device 370. Another embodiment would have the transfer management electronics 320 provide encryption for data being transferred between PPSD 200 and a host device 370. Including encryption functionality helps prevent unauthorized access to data, even while it is being transmitted. In another embodiment, the transfer management electronics 320 would provide authentication services, determining whether a host device 370 was allowed to access PPSD 200. Requiring a host device 370 to authenticate before accessing PPSD 200 serves to prevent unauthorized access to PPSD 200, and also prevents incompatible devices from interfering with the operation of PPSD 200.

The energy source 330, according to one embodiment, is a high-capacity rechargeable battery. According to another embodiment, energy source 330 is a non-rechargeable battery, or a bank of such batteries. According to another embodiment, energy source 330 is a hydrogen fuel cell. One consideration for selecting energy source 330, according to one embodiment, is that it provide sufficient power for PPSD 200 to operate for an extended period before energy source 330 needs to be recharged or replaced, while still allowing for a small form factor for housing 201. A sufficiently long-lasting energy source 330 allows for continual use of PPSD 200 throughout a desired length of operation time without requiring the user to cease usage to recharge or replace the energy source, but energy source 330 should not be so large as to make PPSD 200 too large to carry comfortably about a person, nor should energy source 330 be so heavy as to make PPSD 200 uncomfortable to carry about the person. This embodiment offers a substantial advantage over traditional storage devices, which either require external power via a cord, or else will drain power from the host device they are connected to.

The storage medium 340, according to one embodiment, is a high-capacity hard disk drive (HDD). HDDs provide great cost-effectiveness, with large amounts of storage capacity available for relatively lower cost. According to another embodiment, storage medium 340 is a solid-state storage device, such as a Compact Flash card. Solid-state storage devices have no moving components, are lighter than HDDs, require less power to access, and are designed to be easily removed, but have less available storage capacity and cost relatively more than HDDs. According to another embodiment, storage medium 340 is easily removed from PPSD 200, in order to allow for another storage medium 340 to be inserted. Some users would appreciate such flexibility, which allows them to add more storage with a minimum of inconvenience. According to another embodiment, multiple storage media 340 would be included in PPSD 200, either for greater data redundancy (e.g. configured to provide a redundant array of inexpensive disks (RAID)) or to provide greater capacity.

The bus 350, according to one embodiment, couples the components of PPSD 200 together, providing power from energy source 330 to the other components and carrying data to and from storage medium 340. Bus 350 is not a required element of the present invention; any means of coupling the components would suffice.

With reference to FIG. 4, a flowchart 400 describing a process for data transfer between a PPSD and a host device is shown in accordance with one embodiment of the present invention.

With reference now to step 410 of FIG. 4 and to FIG. 3, a host device 370a would connect to PPSD 200 via a wireless connection 210a by means of wireless component 310.

With reference now to step 420 of FIG. 4 and to FIG. 3, according to one embodiment, the host device 370a would need to be authenticated before a connection could be established. According to one embodiment, authentication takes the form of a password. In another embodiment, authentication is accomplished through the use of encryption. In another embodiment, a host device 370a must be added to a list of authorized host devices maintained on PPSD 200 before access is allowed. Requiring authentication reduces the risk of unauthorized access to or loss of the data stored on PPSD 200. According to another embodiment, no authentication would be necessary. Casual users of PPSD 200 may not require the security offered through authentication, or a sufficiently short-ranged wireless component 310 would reduce the need for such protections.

With reference to step 430 of FIG. 4 and to FIG. 3, host device 370a would request a data transfer. According to one embodiment, the host device 370a would be requesting access to data stored on PPSD 200. According to another embodiment, the host device 370a would be attempting to store data on PPSD 200. According to another embodiment, host device 370 would be attempting to manipulate data stored on PPSD 200.

With reference to step 440 of FIG. 4 and to FIG. 3, the transfer management electronics 320 accesses the storage medium 340. According to one embodiment, transfer management electronics 320 causes storage medium 340 to wake up by causing the disk to begin spinning, in case of a HDD as storage medium 340. According to another embodiment, transfer management electronics 320 begin supplying power, in case of a solid-state storage device as storage medium 340. By only supplying power to the storage medium when it is needed, less power is consumed overall, according to one embodiment. Again, power conservation allows for longer operation of PPSD 200 before energy source 330 must be recharged or replaced. According to one embodiment, the transfer management electronics 320 would then locate the desired data on storage medium 340, in case of a data retrieval or data manipulation request from host device 370a, or else would allocate available storage space, in case of a data storage request from host device 370a.

With reference to step 450 of FIG. 4 and to FIG. 3, data would be transferred wirelessly between PPSD 200 and host device 370a, in accordance with one embodiment. In one embodiment, an entire file would be transferred from PPSD 200 to host device 370a, or from host device 370 to PPSD 200, at the highest possible transfer rate. In another embodiment, data would be streamed from PPSD 200 to host device 370a (e.g. viewing a movie stored on PPSD 200 on a host device), or from host device 370 to PPSD 200 (e.g. storing data from a digital camcorder on PPSD 200 as the data was being recorded).

With reference to step 460 of FIG. 4 and to FIG. 3, the connection between host device 370a and PPSD 200 would be terminated once data transfer is complete, in accordance with one embodiment. Such immediate termination would allow the storage medium 240 to return to low-power usage, or would free up bandwidth for other host devices to use. In another embodiment, host device 370a might remain connected to PPSD 200 until the user performs some action, or for a predetermined length of time. Allowing connections to remain after the end of the immediate data transaction requires more power, but speeds access for subsequent transactions, as there is no need to wake up storage medium 340 again.

While the embodiment illustrated in flow chart 400 shows specific sequences and quantity of steps, the present invention is suitable to alternative embodiments. For example, not all of the steps provided for in flow chart 400 are required for the present invention. Furthermore, additional steps can be added to the steps presented in the embodiment of flow chart 400. Likewise, the sequences of steps can be modified depending upon the application.

With reference to FIG. 5, a flowchart 500 describing a process for data transfer between a PPSD and a plurality of host devices is shown in accordance with one embodiment of the present invention.

With reference now to step 510 of FIG. 5 and to FIG. 3, a host device 370a would connect to PPSD 200 via a wireless connection 210a by means of wireless component 310.

With reference now to step 520 of FIG. 5 and to FIG. 3, according to one embodiment, the host device 370a would need to be authenticated before a connection could be established. Simultaneously, with reference to step 525 of FIG. 5 and to FIG. 3, a host device 370b would connect to PPSD 200 via a wireless connection 210b by means of wireless component 310.

With reference to step 530 of FIG. 5 and to FIG. 3, host device 370a would request a data transfer. Simultaneously, with reference to step 535 of FIG. 5 and to FIG. 3, host device 370b would need to be authenticated. According to one embodiment, the authentication method used in step 520 could differ from that used in step 535, where host device 370a would authenticate using a password, while host device 370b would authenticate by use of encryption.

With reference to step 540 of FIG. 5 and to FIG. 3, the transfer management electronics 320 accesses the storage medium 340, in response to host device 370a's request for data transfer. Simultaneously, with reference to step 545 of FIG. 5 and to FIG. 3, host device 370b would request a data transfer. According to one embodiment, the type of data transfer requested in step 530 would differ from that requested in step 545, allowing for host device 370a to retrieve data stored on PPSD 200 while host device 370b stored new data on PPSD 200.

With reference to step 550 of FIG. 5 and to FIG. 3, data would be transferred wirelessly between PPSD 200 and host device 370a, in accordance with one embodiment. Simultaneously, with reference to step 555 of FIG. 5 and to FIG. 3, the transfer management electronics 320 accesses the storage medium 340, in response to host device 370b's request for data transfer.

With reference to step 560 of FIG. 5 and to FIG. 3, the connection between host device 370a and PPSD 200 would be terminated once data transfer is complete, in accordance with one embodiment. Simultaneously, with reference to step 565 of FIG. 5 and to FIG. 3, data would be transferred wirelessly between PPSD 200 and host device 370b. According to one embodiment, the manner of data transfer could differ between step 550 and step 565, with an entire file being transferred from PPSD 200 to host device 370a as fast as possible, while data is streamed from host device 370b to PPSD 200.

With reference to step 575 of FIG. 5 and to FIG. 3, the connection between host device 370b and PPSD 200 would be terminated once data transfer is complete, in accordance with one embodiment. According to one embodiment, the manner of connection termination could differ between step 560 and step 575, where host device 370a would immediately disconnect following the transfer of data, and host device 370b would remain connected until the user performed some action.

While the embodiment illustrated in flow chart 500 shows specific sequences and quantity of steps, the present invention is suitable to alternative embodiments. For example, not all of the steps provided for in flow chart 500 are required for the present invention. Furthermore, additional steps can be added to the steps presented in the embodiment of flow chart 400. Likewise, the sequences of steps can be modified depending upon the application. Additionally, according to one embodiment, multiple host devices may access PPSD 200 at different times, or simultaneously, rather than only in the manner illustrated in flow chart 500.

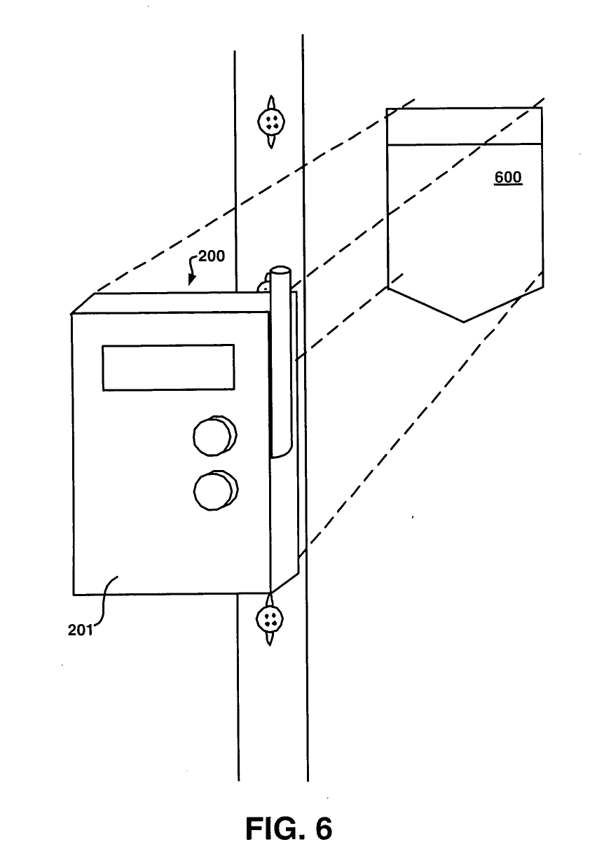

With reference to FIG. 6, the form factor of a PPSD 200 is shown, in accordance with one embodiment. PPSD 200 is constructed so as to fit within comfortably within a standard-sized shirt pocket 600. In another embodiment, housing 201 might incorporate a clip to allow PPSD 200 to attach to a belt. In another embodiment, PPSD 200 might be designed to fit within a pants' pocket. In another embodiment, PPSD 200 might be designed to fit within a suit coat pocket. In another embodiment, PPSD 200 might be designed to fit within a handbag. A primary consideration for the form factor of housing 201 and PPSD 200 is that it be easy to carry on a person, so that PPSD 200 would be readily available for any host devices the user might be carrying or would come in close proximity to.

Embodiments of the present invention described above thus relate to a personal portable storage device as well as a hard disk apparatus configured for use as a personal portable storage device. While the present invention has been described in particular exemplary embodiments, the present invention should not be construed as limited by such embodiments, but rather construed according to the following claims and their equivalents.

What is claimed is:

1. A personal portable storage device (PPSD) comprising:
a storage medium;
a wireless component coupled to said storage medium;
transfer management electronics coupled to said storage medium for allowing a host device to access said PPSD through said wireless component, without requiring physical connections between said PPSD and said host device;
a self-contained energy source coupled to said transfer management electronics; and
a housing of a size and shape well-suited to being carried on a person, said housing at least partially enclosing said storage medium, said wireless component, said transfer management electronics, and said self-contained energy source, such that said PPSD is easily transported.

2. The PPSD of claim 1, where the storage medium is a hard disk drive (HDD).

3. The PPSD of claim 1, where the storage medium is a solid state storage device.

4. The PPSD of claim 1, where the wireless component is a Bluetooth transmitter and receiver.

5. The PPSD of claim 1, where the wireless component is an Ultra-WideBand (UWB) transmitter and receiver.

6. The PPSD of claim 1, where the self-contained energy source is a battery.

7. The PPSD of claim 1, where the self-contained energy source is a hydrogen fuel cell.

8. The PPSD of claim 1, where the housing is designed to be carried on a belt.

9. The PPSD of claim 1, where the housing is designed to be carried in a pocket.

10. The PPSD of claim 1, where the housing includes shock mounting to protect the storage medium from damage.

11. A portable storage device, comprising:
means for storing data;
means for transmitting and receiving data wirelessly;
means for allowing a host device to access said portable storage device without requiring a physical connection between said host device and said portable storage device;
means for providing energy to said portable storage device, said means being self-contained; and
means for at least partially enclosing said portable storage device, said means being of a size and shape well-suited to being carried on a person.

12. The portable storage device of claim 11, where the means for storing data is a hard disk drive (HDD).

13. The portable storage device of claim 11, where the means for storing data is a solid state storage device.

14. The portable storage device of claim 11, where the means for transmitting and receiving data wirelessly is a Bluetooth transmitter and receiver.

15. The portable storage device of claim 11, where the means for transmitting and receiving data wirelessly is an Ultra-WideBand (UWB) transmitter and receiver.

16. The portable storage device of claim 11, where the means for providing energy is a battery.

17. The portable storage device of claim 11, where the means for providing energy is a hydrogen fuel cell.

18. The portable storage device of claim 11, where the means for partially enclosing the portable storage device is designed to be carried on a belt.

19. The portable storage device of claim 11, where the means for partially enclosing the portable storage device is of a size and shape to be carried in a pocket.

20. The portable storage device of claim 11, where the means for partially enclosing the portable storage device includes shock mounting to protect the means for storing data from damage.

21. A hard disk apparatus, configured for use as a personal portable storage device, said hard disk apparatus comprising:
a storage medium;
a wireless component coupled to said storage medium;
transfer management electronics coupled to said storage medium for allowing a host device to access said PPSD through said wireless component, without requiring physical connections between said PPSD and said host device;
a self-contained energy source coupled to said transfer management electronics; and
a housing of a size and shape well-suited to being carried on a person, said housing at least partially enclosing said storage medium, said wireless component, said transfer management electronics, and said self-contained energy source, such that said PPSD is easily transported.

22. The hard disk apparatus of claim 21, where the wireless component is a Bluetooth transmitter and receiver.

23. The hard disk apparatus of claim 21, where the wireless component is an Ultra-WideBand (UWB) transmitter and receiver.

24. The hard disk apparatus of claim 21, where the self-contained energy source is a battery.

25. The hard disk apparatus of claim 21, where the self-contained energy source is a hydrogen fuel cell.

26. The hard disk apparatus of claim 21, where the housing is designed to be carried on a belt.

27. The hard disk apparatus of claim 21, where the housing is of a size and shape to be carried in a pocket.

28. The hard disk apparatus of claim 21, where the housing includes shock mounting to protect the storage medium from damage.
